(19) United States
(12) Patent Application Publication
(10) Pub. No.: US 2012/0191558 A1
(43) Pub. Date: Jul. 26, 2012

(54) Online bidding for waste removal

(76) Inventor: Jeffrey A. Kilimnick, Teaneck, NJ (US)

(21) Appl. No.: 12/930,934

(22) Filed: Jan. 20, 2011

(51) Int. Cl. G06Q 30/00

(52) U.S. Cl. 705/26.3

(57) ABSTRACT

Online bidding for waste removal includes receiving an online request for waste removal from a user. The online request for waste removal comprises a schedule for waste removal and an address identifying a location for the waste removal. In response to the online request, a notification is sent to at least one vendor that an online request is pending. The method includes receiving at least one bid to remove waste. The at least one bid is in response to the online request for waste removal and includes a price. The method also includes presenting a particular bid associated with a particular vendor to the user and providing a time period for the particular bid to be accepted.

### TECHNICAL FIELD

This disclosure relates to online bidding for waste removal.

### BACKGROUND

Homeowners, home owners associations, municipalities, retail locations, office building, industrial sites and other entities (collectively referred to as “clients”) generate waste, such as garbage and recyclable materials (e.g., aluminum cans, cardboard, glass and paper). They hire or contract with waste removal vendors for the removal of their waste. The terms of each contract, such as a price and collection schedule, are specific to each waste removal vendor and each client.

### SUMMARY

The details of one or more implementations of the invention are set forth in the accompanying drawings and the description below. Various aspects are set forth in the claims.

In one aspect, for example, a computer-implemented method includes receiving, at an online service, an online request for waste removal from a user. The online request for waste removal includes a schedule for waste removal and an address identifying a location for the waste removal. In response to the online request, a notification that an online request is pending is sent to at least one vendor. The method also includes receiving at least one bid to remove waste. The bid is in response to the online request for waste removal and includes a price. The method includes presenting a particular bid associated with a particular vendor to the user and provides a time period for the winning bid to be accepted.

Other aspects and features, as well as various advantages, will be apparent from the description and drawings, and from the claims.

### BRIEF DESCRIPTION OF DRAWINGS

FIG. 1 is an illustration of an example system for online bidding for waste removal.

FIGS. 2A-2D are illustrations of example interfaces to request waste removal.

FIG. 3 is an illustration of an example interface to register a waste removal company.

FIG. 4 is an illustration of an example interface to submit a bid for waste removal.

FIG. 5 is an illustration of an example interface to view pending bids.

FIG. 6 is an illustration of an example interface to view bids that have been won.

FIG. 7 is an example process for online bidding for waste removal.

FIG. 8 is an illustration of an example interface to choose the winning bid.

### DETAILED DESCRIPTION

In general, the system described here includes a website that allows a user (e.g., a home owner) to request bids for waste removal services. The website allows the user to specify information, such as the amount of waste (including recyclable materials) to be removed, a schedule for waste removal, and the location of where the waste receptacles are located. After the user enters a request for waste removal services, a bidding period begins, and waste removal vendors registered with the website can submit bids in response to the user's request. The bids can include information such as a price based on the user's requested schedule and/or an alternate schedule for waste removal and a second price based on the alternate schedule. The waste removal vendors can view the lowest bid submitted to the system and submit multiples bid during the bidding period. After the bidding period closes, the system notifies the user of the lowest bid received from the waste removal vendors and allows the user to accept the lowest bid or an alternate proposed bid.

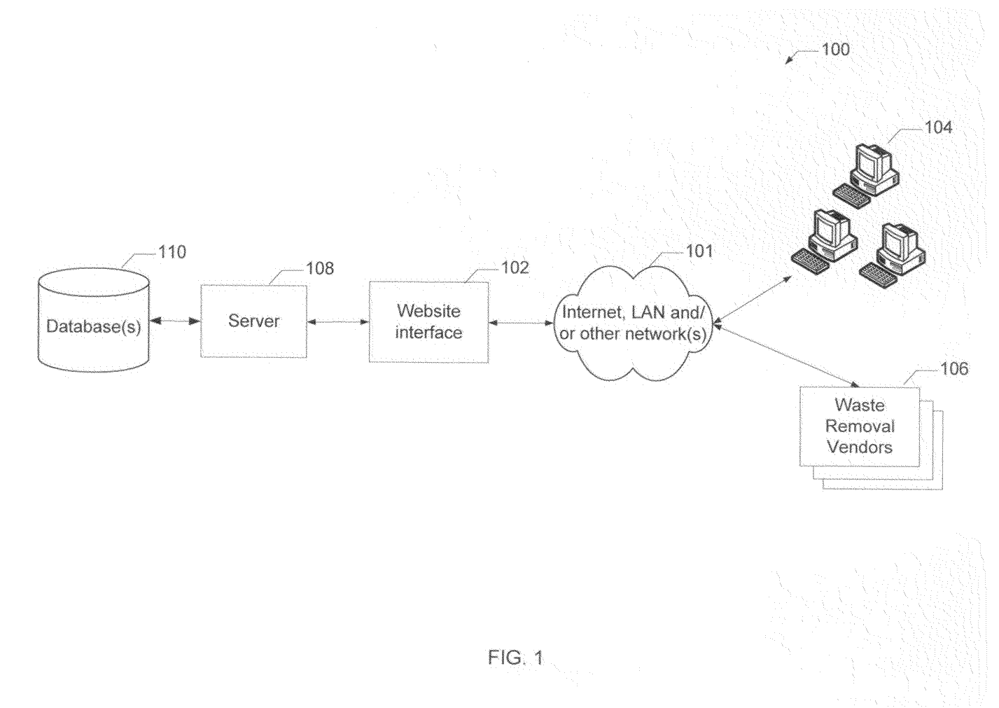

As shown in FIG. 1, a system for online bidding for waste removal includes a network 101, a website interface 102, user devices 104, waste removal vendors 106, a server 108 and a database 110.

Various aspects of the system 100 can be implemented in hardware, software or a combination of hardware and software. Circuitry, including dedicated or general purpose machines, such as computer systems and processors, can be adapted to execute machine-readable instructions to implement the techniques described above. Computer-executable instructions for implementing the techniques can be stored, for example, as encoded information on a computer-readable medium such as a magnetic floppy disk, magnetic tape, compact disc read only memory (CD-ROM), or other machine-readable medium.

The network 101 can be any type of suitable network such as a local area network (LAN), wide area network (WAN), the Internet, or a combination of such networks. The network 101 facilitates connectivity between the website interface 102, the user devices 104, the server 108 and the waste removal vendors 106.

The user devices 104 are associated, for example, with persons representing home owners, home owners associations, retail locations, office buildings, municipalities, industrial sites (e.g., warehouses, factories, and construction sites) and any other entity with waste to be removed. The users can use their devices 104 to interact or connect to the website interface 102. Examples of the user devices 104 include a computer, a laptop, a tablet computer or a smart phone.

The waste removal vendors 106 can be any type of waste removal company. The waste removal companies can be associated with a service area or particular geographical locations in which they operate. For example, Acme Waste Removal can operate within particular towns and/or counties and Beta Garbage can operate nationally. In some implementations, the waste removal vendors 106 are licensed with the local government. For example, the waste removal vendors can be 106 licensed by the state or municipality to remove waste. Like the users of devices 104, the waste removal vendors 106 can interact or connect to the website interface 102 using a device capable of accessing the network 101. Examples of such devices include a computer, a laptop, a tablet computer or a smart phone.

The server 108 can be any type of server or computing system that can host and/or operate the website interface 102. The server 108 can receive information from the user devices 104 and waste removal vendors 106. For example, the server 108 can receive account information associated with the users and waste removal vendors, requests for waste removal submitted by the user and bids submitted in response to the waste removal requests submitted by the waste removal vendors.

In the illustrated example, the server 108 is connected to a database 110 and stores the information received by the website interface 102 in the database 110. The database 110 can be any type of memory or database configured to store information submitted to the website interface 102 or created by the server 108. Although FIG. 1 shows only one server 108 and one database 110, the system 100 can include multiple servers 108 and multiple databases 110.

The website interface 102 is hosted at the server 108 and can be any type of network accessible interface. For example, the website interface 102 can be a website created using HTML or other markup language that can be interpreted by Internet browsers such as Firefox or Internet Explorer.

The website interface 102 allows users to submit requests for waste removal. The website interface 102 can include different interfaces for different types of users to submit requests for waste removal. For example, the website interface 102 can provide customized interfaces for residential users (e.g., home owners), home owners associations, commercial locations (e.g., restaurants, retailers, grocery stores, convenience stores), municipalities, industrial sites and/or office buildings.

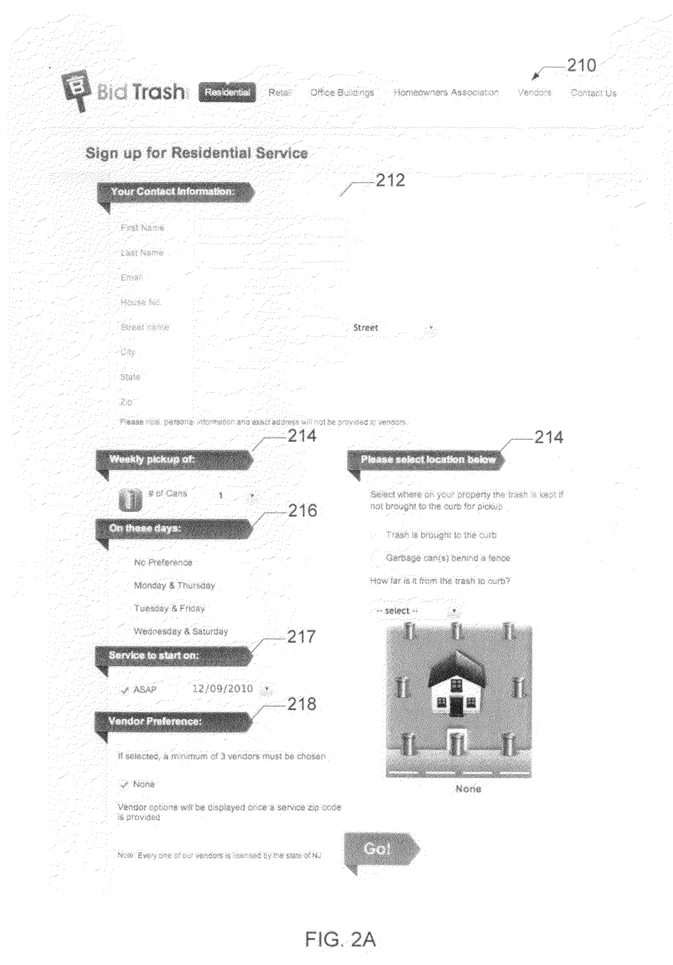

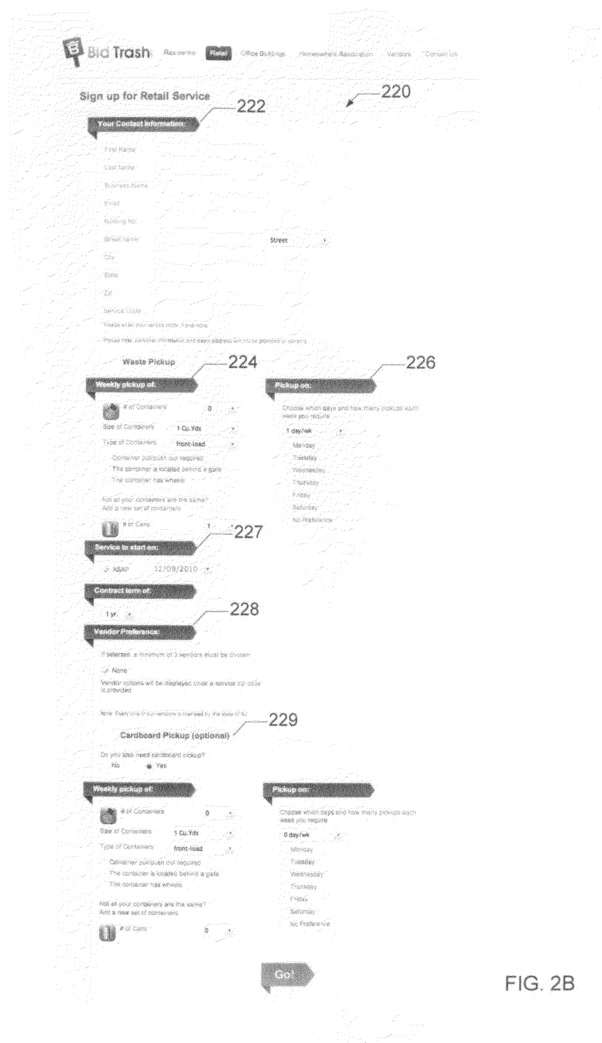

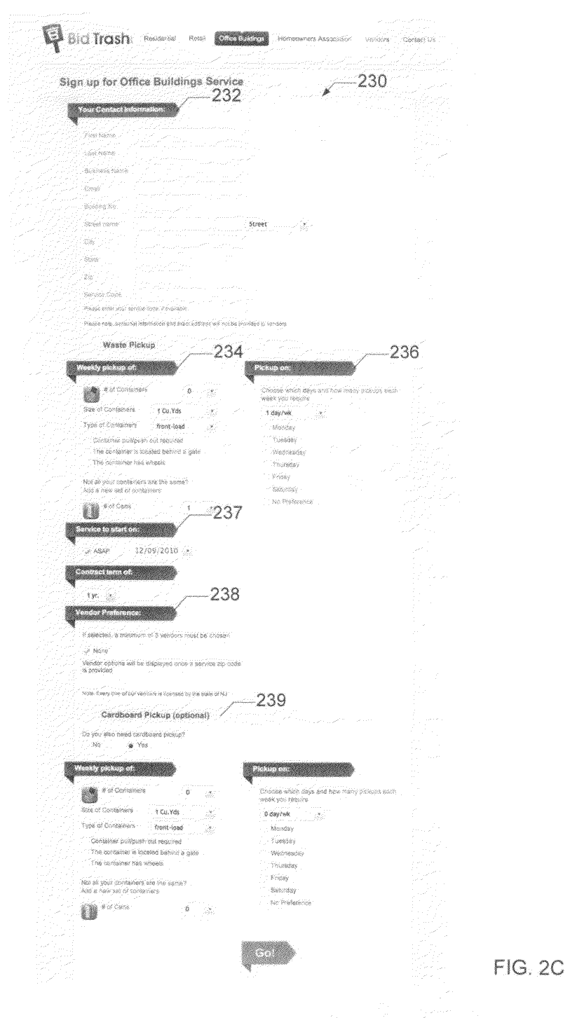

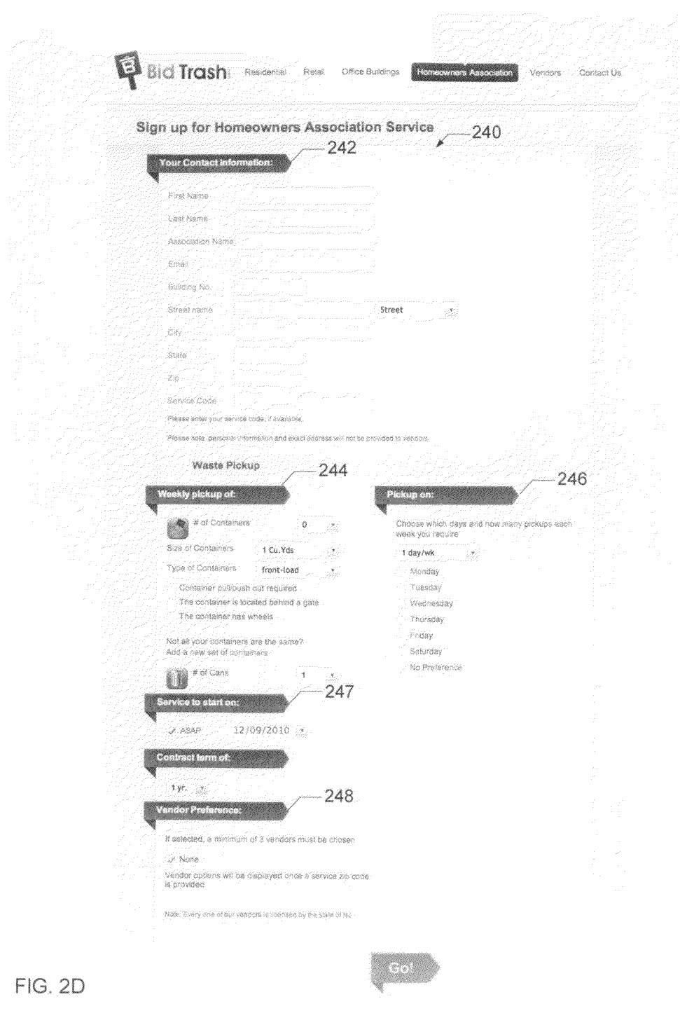

FIG. 2A illustrates an example interface 210 for a residential user to submit a request for waste removal. The interface 210 includes one or more fields 212 for the residential user to enter contact information. For example, the residential user can submit his name, his email address and his street address. In some implementations, other information, such as a phone number, can be submitted in the fields 212.

The interface 210 also includes an input 214 for the residential user to provide information related to the waste that is to be removed. For example, the residential user can use the input 214 to specify the amount of waste that is to be removed (e.g., the number of garbage cans). In some implementations, the residential user can use input 214 to separately specify an amount of recyclable material that should be removed. The input 214 can include, for example, of a drop-down menu to facilitate the user's selection of the amount of waste to be removed.

In addition, the residential user can use the input 214 to specify the location where the waste is kept. For example, the residential user can specify that the garbage cans will be brought to the curb or can indicate where the garbage cans are stored, such as behind a fence, on the right side of the house, behind the house, etc. In some implementations, the input 214 allows the user to specify an approximate distance between the location of the waste containers and the street curb.

The interface 210 also can include an input 216 for the residential user to specify the days of the week the waste should be removed (i.e., a waste removal schedule). For example, the residential user can specify that he has no preference or he can specify specific days of the week the waste should be removed. In addition, the residential user can use input 217 to specify when waste removal services should begin. In some implementations, the residential user can request that the service begin immediately and/or schedule a start date.

The interface 210 also can include an input 218 for the residential user to specify if he has a preference as to vendors. For example, the residential user can specify that he has a preference for a particular waste removal vendor because the particular waste removal vendor has a strong reputation or because the vendor provides waste removal services for the residential user's neighbor. In some implementations, the input 218 requires the residential user to specify at least a minimum number of preferred vendors. For example, the interface 210 can require the residential user to specify at least three preferred vendors. In some implementations, the input 218 allows the user 104 to specify the names of the preferred vendors or can include a list from which the user can select his preferred vendors. In some implementations, the input 218 includes a searchable database.

Some implementations of interface 210 may include additional features; likewise, some implementations may not include all the features discussed above.

FIG. 2B illustrates an example retail interface 220 for commercial users to request waste removal. Commercial users can include any user that represents a business, a restaurant, a bank, a retailer, a grocery market, etc. The interface 220 includes one or more fields 222 for the commercial user to enter contact information. For example, the commercial user can submit her name, her business name, her email address, and address information through the fields 222. In some implementations, the commercial user can submit a service code/promotional code using the fields 222. For example, the commercial user can enter a service code associated with a specific salesperson or can enter a service code. As another example, a commercial user can enter a promotional code that indicates the commercial user is entitled to a discount or some additional benefit.

Like the residential interface 210, the retail interface 220 also can include an input 224 to receive information associated with the amount of waste to be collected. For example, the commercial user can specify the number of waste containers to be collected and information describing the waste containers, such as the size or volume of the containers, the type of containers (e.g., front loading or roll off containers), location of the containers and other information associated with the containers.

In some implementations, the input 224 allows the commercial user to add information about multiple types of waste containers. For example, if the commercial user has multiple types of containers (e.g., a combination of front load dumpsters, garbage cans and roll off containers), the input 224 allows the commercial user to submit information describing each type of container.

The retail interface 220 also can include an input 226 to receive information associated with the waste collection schedule. For example, the commercial user can use input 226 to specify the frequency of waste collection (e.g., once a week, twice a week, nightly or once every two weeks). The commercial user can also use input 226 to specify the days of the week the waste should be collected.

The retail interface 220 also can include an input 227 that receives information associated with the contract. For example, the user can use input 227 to specify that service should begin immediately or can specify a date for service to begin. In some implementations, the user can use input 227 to specify a contract length. For example, the user can use input 227 to specify that the contract term be six months, one year, etc.

The interface 220 also can include an input 228 that receives a commercial user's preferences for vendors. For example, the user can specify that he has a preference for a particular waste removal vendor because the vendor has a strong reputation or because the vendor provides waste removal services for neighboring businesses or retail locations. In some implementations, the input 228 requires the commercial user to specify at least a minimum number of preferred vendors. For example, the interface 228 can require the residential user specify at least three preferred vendors. In some implementations, the input 228 allows the user 104 to specify the names of the preferred vendors or can include a list for the user to select its preferred vendors. In some implementations, the input 228 includes a searchable database.

In some implementations, the retail interface 220 can also include an input 229 to receive information associated with recyclable materials. For example, the commercial user can use the input 229 to specify that she requires collection of recyclable materials such as glass, paper, cardboard, etc. Like the input 224, the input 229 can receive information describing the amount of recyclable materials to be collected, the size of the containers, the number of containers, the location of the containers, etc. In some implementations, the commercial user can specify a recyclable materials collection schedule that is different from the schedule submitted above using input 226.

Some implementations of interface 220 may include additional features; likewise, some implementations may not include all the features discussed above.

FIG. 2C illustrates an example office building interface 230 for users associated with office buildings (i.e., “office building users”) to request waste removal. Office building users can include any user that represents or is associated with an office building, office park, business campus, etc. The interface 230 includes one or more fields 232 for the office building user to enter contact information. For example, the office building user can submit her name, her business name, her email address, and address information through the fields 232. In some implementations, the office building user can submit a service code/promotional code using the fields 232. For example, the office building user can enter a service code associated with a specific salesperson or can enter a service code. As another example, a user can enter a promotional code that indicates the commercial user is entitled to a discount or some additional benefit

Like the retail interface 220, the office building interface 230 also can include an input 234 to receive information associated with the amount of waste to be collected. For example, the commercial user can specify the number of waste containers to be collected and information describing the waste containers, such as the size or volume of the containers, the type of containers (e.g., front loading or roll off containers), location of the containers and other information associated with the containers.

In some implementations, the input 234 allows the office building user to add information about multiple types of waste containers. For example, if the user has multiple types of containers (e.g., a combination of front load dumpsters, garbage cans and roll off containers), the input 234 allows the office building user to submit information describing each type of container.

The office building interface 230 can also include an input 236 to receive information associated with the waste collection schedule. For example, the office building user can use input 236 to specify the frequency of waste collection (e.g., once a week, twice a week, nightly or once every two weeks). The user also can use input 236 to specify the days of the week the waste should be collected.

The office building interface 230 also can include an input 237 that receives information associated with the contract. For example, the user can use input 237 to specify that service should begin immediately or can specify a date for service to begin. In some implementations, the user can use input 237 to specify a contract length. For example, the user can use input 237 to specify that the contract term be six months, one year, etc.

The interface 230 also can include an input 238 that receives an office building user's preferences for vendors. For example, the user can specify that he prefers a particular waste removal vendor because the vendor has a strong reputation or because the vendor provides waste removal services for a neighboring office building. In some implementations, the input 238 requires the user to specify at least a minimum number of preferred vendors. For example, the interface 230 can require the office building user specify at least three preferred vendors. In some implementations, the input 238 allows the user to specify the names of the preferred vendors or can include a list from which the user can select her preferred vendors. In some implementations, the input 238 includes a searchable database.

In some implementations, the retail interface 230 also includes an input 239 to receive information associated with recyclable materials. For example, the office building user can use the input 239 to specify that she requires collection of recyclable materials such as glass, paper, cardboard, etc. Like the input 234, the input 239 can receive information describing the amount of recyclable materials to be collected, the size of the containers, the number of containers, the location of the containers, etc. In some implementations, the user can specify a recyclable materials collection schedule that is different from the schedule submitted above using input 236.

Some implementations of interface 230 may include additional features; likewise, some implementations may not include all the features discussed above.

FIG. 2D illustrates an example HOA interface 240 for users associated with home owners association (i.e., “HOA users”) to request waste removal for the home owners association. The interface 240 includes one or more fields 242 for the HOA user to enter contact information. For example, the HOA user can submit her name, the home owner's association name, her email address, and address information through the fields 242. In some implementations, the HOA user can submit a service code/promotional code using the fields 242. For example, the HOA user can enter a service code associated with a specific salesperson or can enter a service code. As another example, a HOA user can enter a promotional code that indicates the HOA user is entitled to a discount or some other benefit.

Like the retail interface 220, the HOA interface 240 can also include an input 244 to receive information associated with the amount of waste to be collected. For example, the HOA user can specify the number of waste containers to be collected and information describing the waste containers, such as the size or volume of the containers, the type of containers (e.g., front loading or roll off containers), location of the containers and other information associated with the containers.

In some implementations, the input 244 allows the HOA user to add information about multiple types of waste containers. For example, if the user has multiple types of containers (e.g., a combination of front load dumpsters, garbage cans and roll off containers), the input 244 allows the office building user to submit information describing each type of container.

The HOA interface 240 can also include an input 246 to receive information associated with the waste collection schedule. For example, the HOA user can use input 246 to specify the frequency of waste collection (e.g., once a week, twice a week, nightly or once every two weeks). The user also can use input 246 to specify the days of the week the waste should be collected.

The HOA interface 240 also can include an input 247 that receives information associated with the contract. For example, the user can use input 247 to specify that service should begin immediately or can specify a date for service to begin. In some implementations, the user can use input 247 to specify a contract length. For example, the user can use input 247 to specify that the contract term to be six months, one year, etc.

The interface 240 can also include an input 248 that receives an HOA user's preferences for vendors. For example, the user can specify that he has a preference as to a particular waste removal vendor that has a strong reputation or a waste removal vendor that provides waste removal services for a neighboring home owner's associations. In some implementations, the input 248 requires the user to specify at least a minimum number of preferred vendors. For example, the interface 248 can require the office building user specify at least three preferred vendors. In some implementations, the input 248 allows the user 104 to specify the names of the preferred vendors or can include a list from which the user can select her preferred vendors. In some implementations, the input 248 includes a searchable database.

In some implementations, the retail interface 240 includes an input to receive information associated with recyclable materials. For example, the office building user can use the input to specify that she requires collection of recyclable materials such as glass, paper, cardboard, etc. Like the input 244, the input on interface 240 can receive information describing the amount of recyclable materials to be collected, the size of the containers, the number of containers, the location of the containers, etc. In some implementations, the user can specify a recyclable materials collection schedule that is different from the schedule submitted above using input 246.

Some implementations of interface 240 may include additional features; likewise, some implementations may not include all the features discussed above.

The website interface 102 also allows waste removal vendors 106 to create accounts and register with the website interface 102 and/or server 108. The website interface 102 can include an interface that allows a waste removal vendor to create an account associated with the website interface 102 and the server 108.

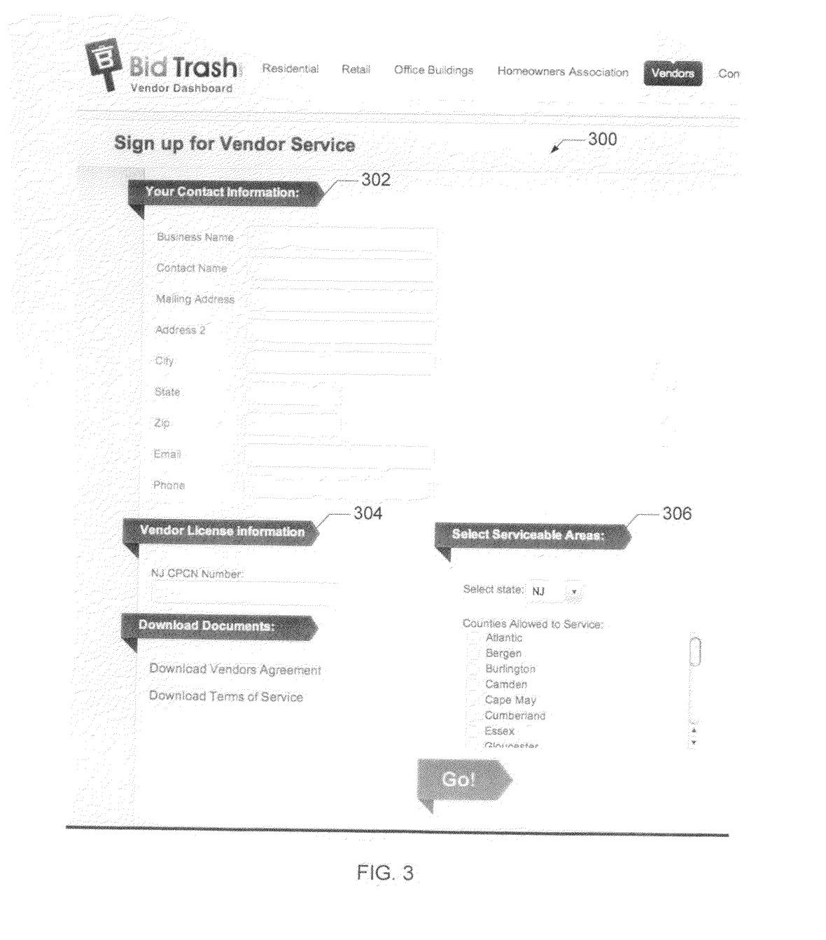

FIG. 3 illustrates an example of a vendor sign-up interface 300. The vendor sign-up interface 300 includes an input 302 that receives the waste removal vendor's contact information. For example, the waste removal vendor 106 can provide its business name, a name of a contact person, an email address, a phone number, an address and other contact information, such as a URL or fax number.

In some implementations, the vendor signup interface 300 includes an input 304 to receive the waste removal vendor's license number. For example, some states and/or local governments require that waste removal vendors 106 be licensed and regulated by the state or local government officials. In some implementations, the interface 300 can be connected to the state or local government's database of vendor license numbers and allow for searching or lookup capabilities.

The vendor signup interface 300 also can include an input 306 to receive information associated with the waste removal vendor's service areas (e.g., towns or counties in which the waste removal vendor 106 collects waste). For example, the input 306 can allow the waste removal vendor to specify a state and the counties within the state in which the vendor operates. In some implementations, the input 306 allows the waste removal vendor to submit more specific information, such as zip codes, town names within a county and/or neighborhoods within a town. In some implementations, the input 306 can receive a spreadsheet or database file from the waste removal vendor 106 that specifies the vendor's service areas.

The website interface 102 also can include an interface for the waste removal vendor 104 to submit a proposal/bid in response to a user's request for waste collection. For example, after a user submits a request for waste collection from device 104, a waste removal vendor 106 that operates in the user's town or county receives a notification that a request for waste removal has been received by the system and that the waste removal vendor can submit a proposal/bid. In some implementations, only waste removal vendors 106 who have registered with the website interface 102 and/or have been approved by the operator or a system administrator of the website interface 102 or server 108 are able to submit a bid. The waste removal vendor 106 can submit a proposal/bid in response to the user's request during a predetermined bidding period. For example, the predetermined bidding period can be seventy-two hours. During the bidding period, a waste removal vendor 106 can submit multiple bids to secure the lowest bid. For example, the vendor 106 can submit multiple proposals/bids during the seventy-two hour bidding period.

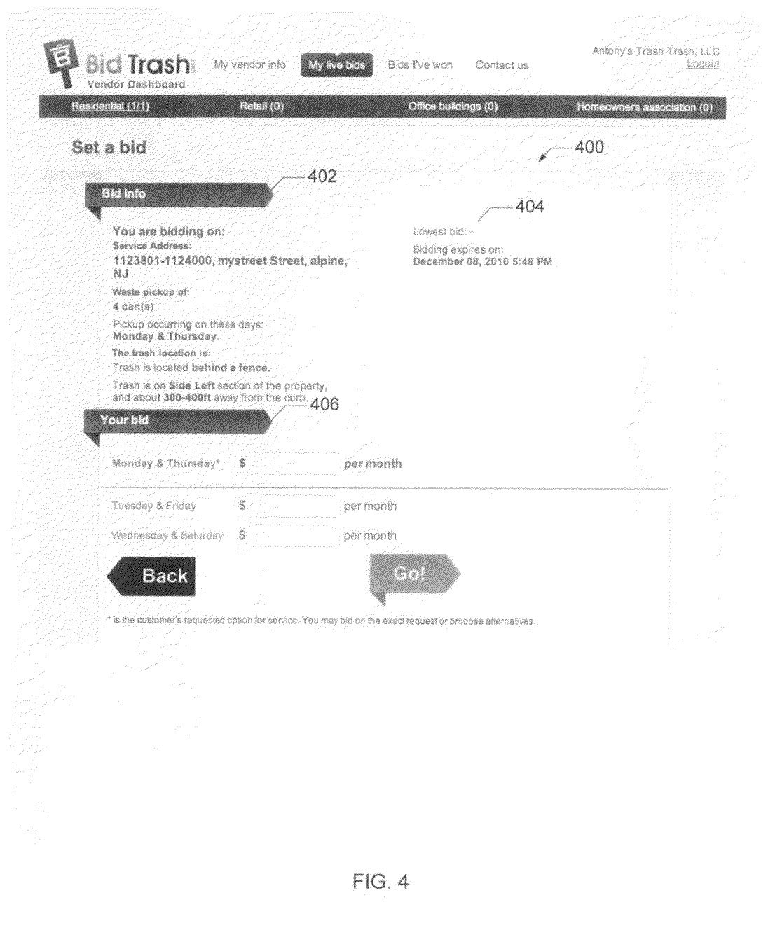

FIG. 4 illustrates an example of a bidding interface 400 that allows a waste removal vendor 106 to submit proposals/bids for pending requests for waste removal. The bidding interface 400 includes a request information section 402 that displays information associated with the pending user request for waste collection. The information section 402 can display the user's address, the amount of waste to be collected (e.g., the number of garbage cans, the size of the containers, the types of containers) and information describing the location of the waste containers. The information section 402 also can display information describing the collection schedule requested by the user. In some implementations, the information section 402 does not display the exact street address associated with the user's request. Instead, the information section 402 displays information describing a particular portion of the street on which the user has requested service or generally describe the address. For example, if the user requested service at 153 W Main Street, instead of displaying 153 W Main Street, the information section 402 displays the intersection information nearest to 153 W. Main Street or provides the first and last building number of the block of W Main Street that includes 153 W. Main Street (e.g., 100-150 W. Main Street).

The bidding interface 400 also can include a request status section 404 that provides status updates related to the user's request. For example, the request status section 404 can display information related to the lowest bid submitted in response to the user's request, the date and time the bidding period ends, and/or an amount of time remaining in the bidding period.

The bidding interface 400 also includes a bidding input 406. The bidding input 406 receives a waste removal vendor's proposal/bid in response to the user's request for waste removal. For example, the waste removal vendor 106 can provide a price for collecting the user's waste based on the user's requested schedule. For clarity, it is noted that the price for collection of the user's waste is the amount of money the user would pay the waste removal vendor to collect the user's waste for a period of time (e.g., a monthly rate). In addition, the bidding input 406 also can receive a waste removal vendor's alternate proposals/bids. For example, the waste removal vendor may provide a first bid/proposal based on the user's requested collection schedule, but can also submit a second bid/proposal based on an alternate collection schedule. The waste removal vendor 106 may be able to provide the second bid/proposal at a lower cost than the first bid/proposal if, for example, the waste removal vendor 106 already is collecting waste at another address near the user's address. Similarly, the vendor 106 might have more capacity to collect waste on the alternate days.

The waste removal vendor 106 can submit multiple bids using the bidding interface 400 during the bidding period. For example, the Acme Waste Removal can submit a first bid and, as additional bids are submitted by other waste removal vendors 106, Acme Waste Removal can inspect the lowest submitted bid and submit additional bids to compete with the other vendors and secure the lowest bid.

The website interface 102 can also include an open bid interface that allows the waste removal vendor 106 to review the bids it submitted in response to user requests or the user requests that have an open bidding period and which it is able to submit a bid.

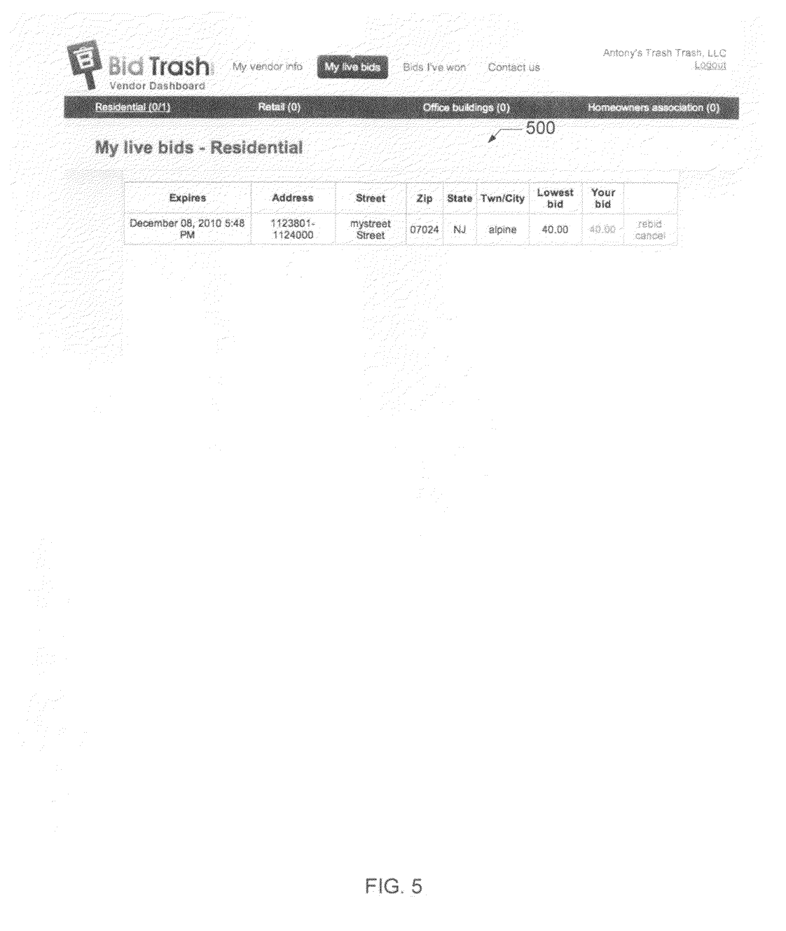

FIG. 5 illustrates an example of an open bid interface 500. The open bid interface 500 displays information related to the user requests the waste removal vendor previously submitted a bid. The open bid interface can display information similar to the information section 402 and the request status section 404, such as address information, the date and time the bidding period ends, the lowest submitted bid and the waste removal vendor's bid. The open bid interface 500 can include a link or an input to allow the waste removal vendor to submit a new bid. For example, the open bid interface 500 can include a link to the bidding interface 400. The open bid interface 500 also can include a link or input that allows the waste removal vendor 106 to cancel its pending bid.

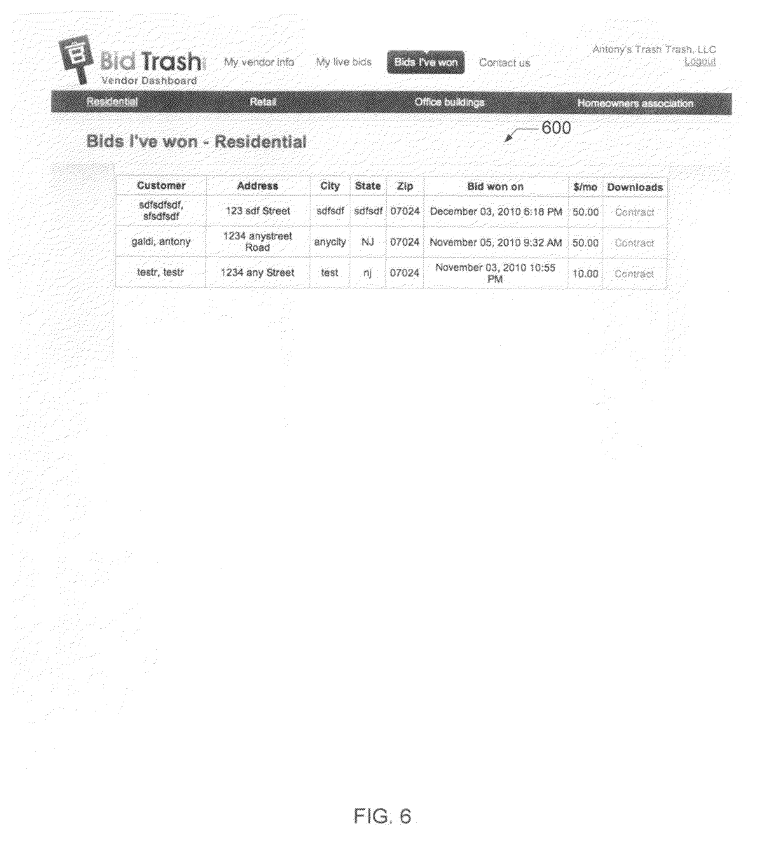

The website interface 102 also can include an interface that allows the waste removal vendor 106 to review the contracts it has secured (i.e., a proposal/bid that was accepted by the user 104). For example, the website interface 102 can include a contracts summary interface that displays the information about each contract it has secured. FIG. 6 illustrates an example of a contracts summary interface 600. The contracts summary interface 600 displays the user's name, the user's address, the date the waste removal vendor's proposal/bid was accepted by the user, the amount of the waste removal vendor's proposal/bid and the collection schedule. In some implementations, the contracts summary interface 600 includes a link to the full terms and conditions of the contract between the user 104 and the vendor 106.

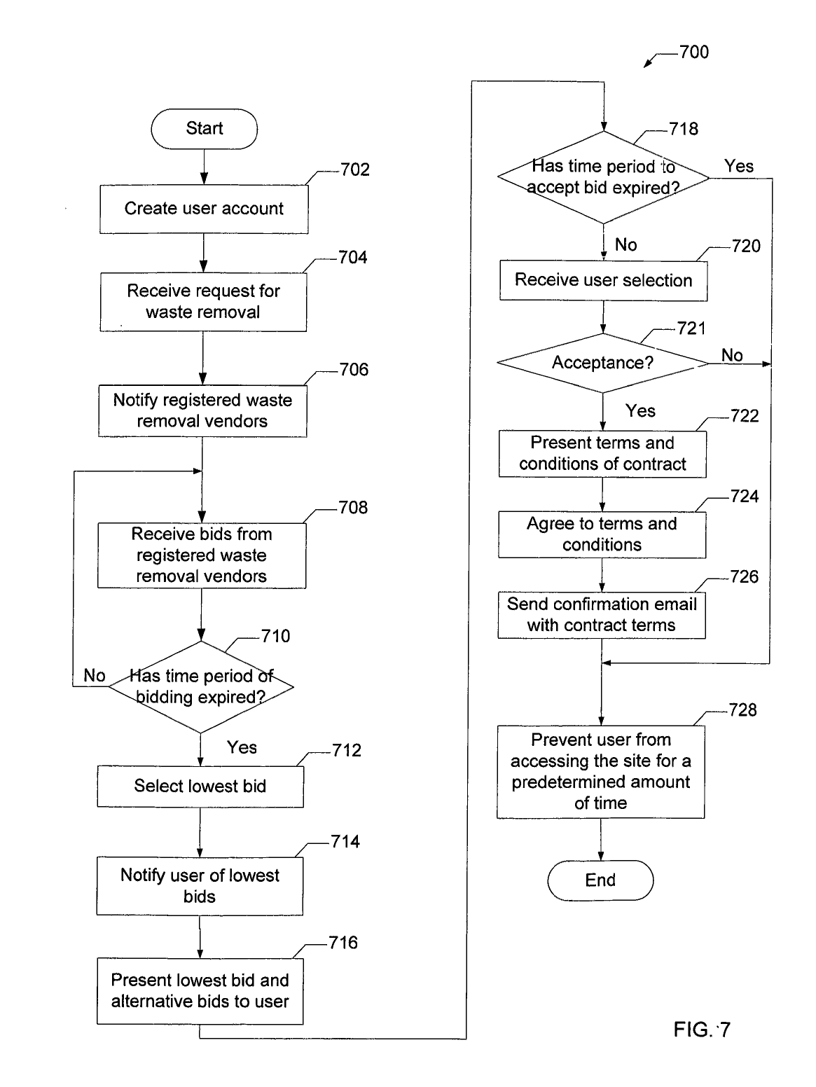

FIG. 7 is an example of a process for online bidding for waste removal. The process 700 begins when the user account is created (at step 702). For example, a user device 104 can interact with the website interface 102 when the user provides information, such as an email address, contact information, a street address, etc. The server 108 then can create a user account for the user based on the received information. The website interface 102 and/or the server 108 can create different types of user accounts (e.g., residential account or a HOA account) based on whether the user 104 represents a home owner, home owners associations, retail locations, office buildings, municipalities, industrial sites or some other type of entity with waste to be removed. The user's account information is stored in the database 110.

At step 704, a request for waste removal is received. For example, after a user creates the user account, the user can submit his request for waste collection, and the request is received by the website interface 102 and the server 108. In some implementations, the user interacts with an interface, such as interfaces 210, 220, 230 or 240, and submits the details of its request for service. For example, the user can submit address information, information describing the waste to be removed, information describing the waste containers and a schedule for waste collection. The server 108 can store the user request in the database 110.

At step 706, waste removal vendors are notified of the user request. For example, the website interface 102 and/or the server 108 send a message to notify registered waste removal vendors of the user request. Various types of messages can be sent. For example, an email, an instant message, a facsimile or text message can be sent to the waste removal company or to a representative at the waste removal company. In some implementations, the server 108 determines which waste removal vendors have service areas covering the address provided by the user and only notifies the waste removal vendors that have service areas covering the address provided by the user. For example, if the user's address is in Morristown, NJ, the server 108 would send the notification message only to waste removal vendors having service areas that include Morristown, N.J. As another example, the server 108 can use the user's zip code and notify only waste removal vendors having service areas that include the zip code. In some implementations, only the vendors 106 that the user specified as a preferred vendor are notified of the user request. The server 108 then opens the bidding period and allows waste removal vendors to submit bids to service the user request.

At step 708, proposals/bids are received from the waste removal vendors 106 that were notified of the user request. For example, a waste removal vendor can use bidding interface 400 to submit a proposal/bid in response to the user's request for waste removal and the proposal/bid can be transmitted to the server 108. The proposal/bid can include a price at which the vendor is offering to collect the user's waste on the days specified in the user's request. The waste removal vendor also can submit alternate proposals/bids. For example, the waste removal vendor can submit an alternate proposal/bid with a second price and a collection schedule that is different than the schedule requested by the user.

The website interface 102 and/or the server 108 can receive bids from the waste removal vendors during the bidding period (at step 708). For example, the server 108 and/or the website interface 102 can specify that the bidding period is open for seventy two hours after the user request is received. Other bidding periods are available. During the seventy two hour bidding period, the waste removal vendors 106 can submit bids and adjust their proposal/bids based on the lowest bid submitted by other vendors. For example, a waste removal vendor using interface 500 can determine the lowest bid submitted for a particular user request for waste removal and if the vendor's bid is higher than the lowest bid, it can submit a new proposal/bid that is lower than the lowest bid displayed on the interface 500. In addition, the waste removal vendor 106 can alter its alternate bids/proposals during the open bidding period. In some implementations, the interface 500 provides set increments for the waste removal vendor 106 to alter its proposals/bids. For example, the interface 500 can allow the waste removal vendor 106 to alter its bids using increments of $1, $5, $10, etc. The amount that the bid can be altered can depend on the type of service that is requested by the user (e.g., residential service or office building service). In some implementations, the waste removal vendor 106 cannot provide the same bid as the lowest bid and must submit a lower bid. For example, if the lowest bid is $40, the waste removal vendor cannot submit a bid for $40 and can only submit a bid for less than $40 (e.g., $39).

At step 710, the process determines whether the bidding time period has expired. If the bidding time period has not expired, then additional bids can be received. If the bidding period has ended, the lowest bid is selected (at step 712). For example, the server 108 can analyze the bids received and select the lowest bid submitted by a waste removal vendor 106 in response to the user's exact request (e.g., the proposal is based on collecting waste on the schedule specified by the user).

At step 714, a message is sent to the user who submitted the request for waste removal to notify the user that the bidding period has ended. For example, the server 108 and/or the website interface 102 can transmit a message, such as an email or a text message, to the user notify the user 104 that the bidding period has expired and that a proposal/bid is available for review. In some implementations, the message is valid for a limited time period (e.g., 5 days, 7 days, or two weeks) such that the user can access the website interface 102 and view the lowest bid only during the time period. For example, a message can be sent to the user and the user can only view the lowest bid for seven days. After the seven days expire, the user cannot view the lowest bid and the server 108 and/or website interface 102 can interpret this to be a rejection of the proposal/bid.

At step 716, the lowest bid and alternate bids are presented to the user. In some implementations, the user can access the website interface 102 to review the lowest bid. For example, the user can review the lowest bid using a selection interface.

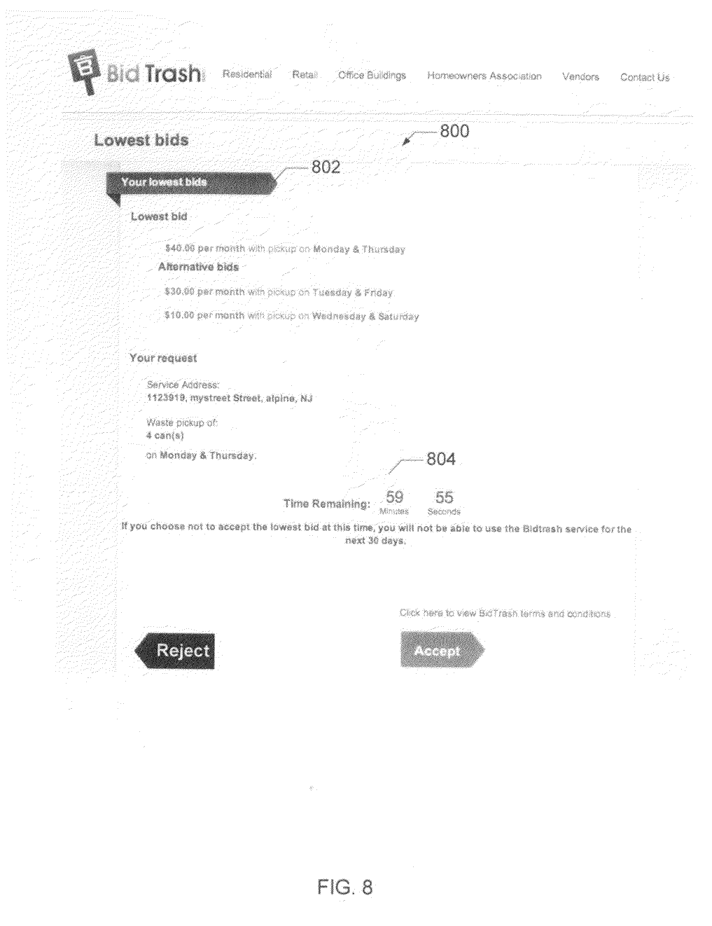

FIG. 8 illustrates an example of a selection interface 800. The selection interface 800 includes a selected proposal/bid section 802 that displays the lowest bid based on the user's request. In addition, the selected proposal/bid section 802 can include alternate proposals/bids that were submitted by the waste removal vendor 106 associated with the lowest bid. As seen in the example of FIG. 8, the lowest bid is $40/month with scheduled collection on Monday and Thursday, a first alternate proposal of $30/month with scheduled collection on Tuesday and Friday and a second alternate proposal of $10/month with scheduled collection on Wednesday and Saturday are presented to the user 104. The selected proposal/bid section 802 can include buttons or interactive links that enable the user to select a proposal/bid. For example, radio buttons or check boxes can be used.

The illustrated selection interface 800 also includes a time remaining section 804. The time remaining section 804 includes a timer or some other indication as to when the time period for accepting the waste vendor's proposal. In some implementations, the server 108 and/or website interface 102 specifies that the user has three hours to accept the bid. Other time periods to accept the bid can be specified by the server 108. In some implementations, the time period to accept the proposal begins after the user reviews the lowest bid, whereas in other implementations, the time period to accept the proposal begins when the user is notified of the lowest bid.

The server 108 determines if the time period for accepting the bid has expired (at step 718). If the time period has not expired, the website interface 102 and/or the server 108 can receive the user's selection (at 720). For example, the user can accept the lowest bid or an alternate bid using the selection interface 800. If the user rejected the lowest bid (at step 721), the process continues at step 728, described below.

If the user accepts the lowest bid (at step 721), the terms and conditions are presented to the user (at step 722). For example, the website interface 102 can display terms and conditions of a contract, which the user can view on his device 104. The terms and conditions can present the user's rights provided by any local government or can present a various disclaimers. The terms and conditions must be accepted in order to complete the acceptance of the lowest bid.

After the terms and conditions are accepted (at step 724), a confirmation message is transmitted to the user device 104 and to the waste removal vendor 106 that submitted the lowest bid (at step 726). For example, the server 108 can send an email, text message or facsimile to the user device 104 and the waste removal vendor 106 that submitted the lowest bid. The message can include details of the user request, the proposal/bid and the contact information associated with the user and the waste removal vendor 106. An example of the message is displayed in FIG. 9. In some implementations, the confirmation message is transmitted to the user device 104 and to the waste removal vendor 106 simultaneously.

After the user accepts the lowest bid (at step 721) or if the time period for accepting the lowest bid expires (at step 716), the process 700 prevents the user from accessing the website interface 102 and/or the user's user account for a predetermined amount of time (at step 728). For example, the server 108 can prevent the user from accessing his user account and/or submitting another request for waste removal services at the same address for a predetermined amount of time. The predetermined amount of time can vary from weeks, months to years. In some implementations, the server 108 prevents the user from accessing the website interface 102 for eleven months.

A number of implementations have been described. Nevertheless, it will be understood that various modifications can be made. For example, in some implementations, the website interface 102 and/or server 108 are configured to handle the waste vendors' administrative tasks, such as the waste removal vendors' book keeping, mailing of invoices, sending reminders to users, etc. For example, the website interface 102 and/or server 108 can receive payments from the user and/or waste removal vendors 106. The website interface 102 and/or server 108 can be configured to receive a payment from the user 104 for the waste collection services provided by the waste removal vendor 106. The website interface 102 and/or server 108 can provide the payment from the user to the waste removal vendor 106. In some implementations, the website interface 102 and/or server 108 transfers the full amount of the payment from the user to the waste removal vendor 108 or can subtract a fee from the payment and then transfer the remainder to the waste removal vendor 108.

In some implementations, the bidding interface 402 and/or the website interface 102 can include an input to allow the waste removal vendor to set a minimum price it is willing to bid (i.e., a minimum bid). For example, Acme waste removal can specify a minimum price of $30, and the system will automatically update the Acme's bid such that it has the lowest bid until the $30 limit is reached. As other waste removal vendors submit bids, the system will update the Acme's bid such that it maintains the lowest bid until another waste removal vendor bids below $30. In some implementations, the bid is updated based on an incremental value set by the waste removal vendor 106 (e.g., $1, $5 or $10), as described above. The fee can be a percentage of a contract price or of the price of the monthly service.

Other implementations are within the scope of the following claims.

What is claimed is:

1. A computer-implemented method comprising:
receiving, at an online service, an online request for waste removal from a user, wherein the online request for waste removal comprises a schedule for waste removal and an address identifying a location for the waste removal;
in response to the online request, sending a notification to at least one vendor that an online request is pending;
receiving at least one bid to remove waste, wherein the at least one bid is in response to the online request for waste removal and comprises a price;
presenting a particular bid associated with a particular vendor to the user; and
specifying a time period for the particular bid to be accepted by the user.

2. The computer-implemented method of claim 1, wherein the particular bid comprises a bid having the lowest price.

3. The computer-implemented method of claim 1, wherein the particular bid is received during a bidding period having a predetermined duration.

4. The computer-implemented method of claim 1, wherein the notification comprises an email, a text message or an automated voice mail.

5. The computer-implemented method of claim 1, wherein the online request further comprises at least one of the following: an amount of waste to be removed, a description of waste containers, a description of the location of the waste containers or a contract term length.

6. The computer-implemented method of claim 1, wherein the at least one bid further comprises an alternative proposal comprising a price and an alternate schedule, wherein the alternate schedule is different from the schedule for waste removal.

7. The computer-implemented method of claim 6 wherein the alternative proposal further comprises an alternate contract term length.

8. The computer-implemented method of claim 1 further comprising:
presenting a second bid at the same time the particular bid is presented, wherein the second bid comprises an alternative proposal comprising a price and an alternate schedule, wherein the alternate schedule is different from the schedule for waste removal.

9. The computer-implemented method of claim 1 further comprising:
preventing the user from submitting a second online request for waste removal through the online service for a predetermined amount of time if the user does not accept the particular bid.

10. The computer-implemented method of claim 1, wherein the at least one vendor comprises a waste removal company.

11. The computer-implemented method of claim 10, wherein the waste removal company comprises a pre-approved waste removal company.

12. The computer-implemented method of claim 11, wherein the approved waste removal company is pre-approved by a system administrator.

13. The computer-implemented method of claim 1, wherein the online request for waste removal is for a residence, a retail location, an office building, an industrial site or a homeowner's association.

14. The computer-implemented method of claim 1 further comprising:
receiving an acceptance of the particular bid over a communications network;
notifying the particular vendor associated with the particular bid of the acceptance; and
preventing the user from submitting a second online request for waste removal through the online service for a second predetermined amount of time.

15. The computer-implemented method of claim 1 further comprising:
receiving a payment from the waste removal vendor.

16. The computer-implemented method of claim 1 further comprising:
receiving a payment in the amount of the price associated with the particular bid from the user; and
providing at least a portion of the payment to the waste removal vendor.

17. The computer-implemented method of claim 1 wherein the receiving at least one bid and presenting the particular bid are performed over a communications network.

18. The computer-implemented method of claim 1 further comprising receiving a minimum bid.

19. A computer readable medium encoded with a computer program comprising instructions that, when executed, operate to cause a computer system to:
in response to receiving an online request for waste removal from a user, send a notification to at least one vendor that an online request is pending, wherein the online request for waste removal comprises a schedule for waste removal and an address identifying a location for the waste removal;
present a particular bid associated with a particular vendor to the user in response to receiving at least one bid to remove waste the at least one bid being in response to the online request for waste removal and including a price; and
specify a time period for the particular bid to be accepted by the user.

20. The computer readable medium of claim 19 wherein the computer program further comprises instructions that, when executed, operate to cause the computer system to:
present a second bid to the user at the same time the particular bid is presented, wherein the second bid comprises an alternative proposal comprising a price and an alternate schedule, wherein the alternate schedule is different from the schedule for waste removal.

21. The computer readable medium of claim 19 wherein the computer program further comprises instructions that, when executed, operate to cause the computer system to:
prevent the user from submitting a second online request for waste removal through the online service for a predetermined amount of time if the user does not accept the particular bid.

22. The computer readable medium of claim 19 wherein the computer program further comprises instructions that, when executed, operate to cause the computer system to:
in response to receiving an acceptance of the particular bid, notify the particular vendor and the user associated with the particular bid of the acceptance; and
prevent the user from submitting a second online request for waste removal for at least a specified time.

23. A system, comprising:
a database; and
a server coupled to the database and configured to:
in response to receiving an online request for waste removal from a user, send a notification to at least one vendor that an online request is pending, wherein the online request for waste removal comprises a schedule for waste removal and an address identifying a location for the waste removal;
present a particular bid associated with a particular vendor to the user in response to receiving at least one bid to remove waste the at least one bid being in response to the online request for waste removal and including a price; and
specify a time period for the particular bid to be accepted by the user.

24. The system of claim 23, wherein the server is further configured to:
present a second bid at the same time the particular bid is presented, wherein the second bid comprises an alternative proposal comprising a price and an alternate schedule, wherein the alternate schedule is different from the schedule for waste removal.

25. The system of claim 23, wherein the server is further configured to:
prevent the user from submitting a second online request for waste removal through the online service for a predetermined amount of time if the user does not accept the particular bid.

26. The system of claim 23, wherein the server is further configured to:
receive an acceptance of the particular bid;
notify the particular vendor associated with the particular bid and the user of the acceptance; and
prevent the user from submitting a second online request for waste removal.
